(19) United States
(12) Patent Application Publication
(10) Pub. No.: US 2011/0211816 A1
(43) Pub. Date: Sep. 1, 2011

(54) Method and apparatus for synchronized workstation with two-dimensional and three-dimensional outputs

(76) Inventors: Richard Edwin Goedeken, Santa Clarita, CA (US); Jesus Barcons-Palau, Burbank, CA (US); Joan Llach, Cesson-Sevigne Cedex (FR)

(21) Appl. No.: 12/932,156

(22) Filed: Feb. 18, 2011

Related U.S. Application Data
(60) Provisional application No. 61/306,886, filed on Feb. 22, 2010.

(51) Int. Cl. H04N 5/93

(52) U.S. Cl. 386/354; 386/E05.007; 386/E05.003

(57) ABSTRACT

A method and apparatus are disclosed and described for providing a synchronized workstation with two-dimensional and three-dimensional outputs. The apparatus includes a video decoder (315) for decoding picture data. The video decoder includes a data manager (320) for receiving video production commands and managing a video playback of the picture data in at least one of a two-dimensional video output mode and a three-dimensional video output mode responsive to the video production commands. The two-dimensional video output mode and the three-dimensional video output mode are capable of being used independently and simultaneously.

### CROSS-REFERENCE TO RELATED APPLICATIONS

This application claims the benefit of U.S. Provisional Application Ser. No. 61/306,886, filed Feb. 22, 2010, which is incorporated by reference herein in its entirety.

### TECHNICAL FIELD

The present principles relate generally to video decoding and, more particularly, to a method and apparatus for a synchronized workstation with two-dimensional (2D) and three-dimensional (3D) outputs.

### BACKGROUND

Viewing video in a two-dimensional (2D) environment has been familiar to everyone since the inventions of film and television. Regarding such a 2D environment, images projected on a single screen are viewed by both the left and right eyes of the viewer. Each eye sees the same image from a slightly different perspective.

However, viewing three-dimensional (3D) video is a fundamentally different experience. Through the use of special screens, lenses, or glasses, the projection system delivers different images to the left and right eyes of the viewer for each video frame in a video sequence. The differences (called disparity) between the images projected into each eye produce a 3D visual effect in the mind of the viewer.

The BLU-RAY video storage media standard has been extended to support new 3D video encoding technology in addition to the original single-view (2D) video mode. Companies (such as TECHNICOLOR) which do production work on 3D video must ensure the highest possible video quality for both 2D and 3D viewing modes, since 3D BLU-RAY discs created in accordance with the extended BLU-RAY standard are backwards-compatible with respect to older 2D players and may be viewed in either mode.

Real-time video playback is common in video processing tools, but 3D video formats have only recently been standardized, so relatively few tools support 3D video processing. As such, the problem of displaying synchronized 2D and 3D video outputs simultaneously is a new and particularly difficult problem.

### SUMMARY

These and other drawbacks and disadvantages of the prior art are addressed by the present principles, which are directed to a method and apparatus for a synchronized workstation with two-dimensional (2D) and three-dimensional (3D) outputs.

According to an aspect of the present principles, there is provided an apparatus. The apparatus includes a video decoder for decoding picture data. The video decoder includes a data manager for receiving video production commands and managing a video playback of the picture data in at least one of a two-dimensional video output mode and a three-dimensional video output mode responsive to the video production commands. The two-dimensional video output mode and the three-dimensional video output mode are capable of being used independently and simultaneously.

According to another aspect of the present principles, there is provided a method in a video decoder. The method includes receiving video production commands, and managing a video playback of the picture data in at least one of a two-dimensional video output mode and a three-dimensional video output mode responsive to the video production commands. The two-dimensional video output mode and the three-dimensional video output mode are capable of being used independently and simultaneously.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram showing an exemplary computer system to which the present invention may be applied, in accordance with an embodiment of the present principles;

FIG. 2 is a block diagram showing an exemplary integrated 2D/3D workstation, in accordance with an embodiment of the present principles;

FIG. 3 is a block diagram showing an exemplary software arrangement for the integrated 2D/3D workstation 200 shown in FIG. 2, in accordance with an embodiment of the present principles;

FIG. 4 is a block diagram showing an exemplary multi-view video decoder, in accordance with an embodiment of the present principles; and

FIG. 5 is a flow diagram showing an exemplary method for synchronizing two-dimensional and three-dimensional video outputs, in accordance with an embodiment of the present principles.

### DETAILED DESCRIPTION

The present principles are directed to a method and apparatus for a synchronized workstation with two-dimensional (2D) and three-dimensional (3D) outputs.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Also, as used herein, the words “picture” and “image” are used interchangeably and refer to a still image or a picture from a video sequence. As is known, a picture may be a frame or a field.

Additionally, as used herein, the words “pre-processing” refer to processing of a signal prior to subjecting the signal to another process (e.g., decoding). Moreover, the words “post-processing” refer to processing of a signal subsequent to the signal having been subjected to another process. Thus, as one example, pre-processing may involve filtering a signal prior to decoding the signal. These and other examples of pre-processing and post-processing are readily contemplated by one of ordinary skill in the art.

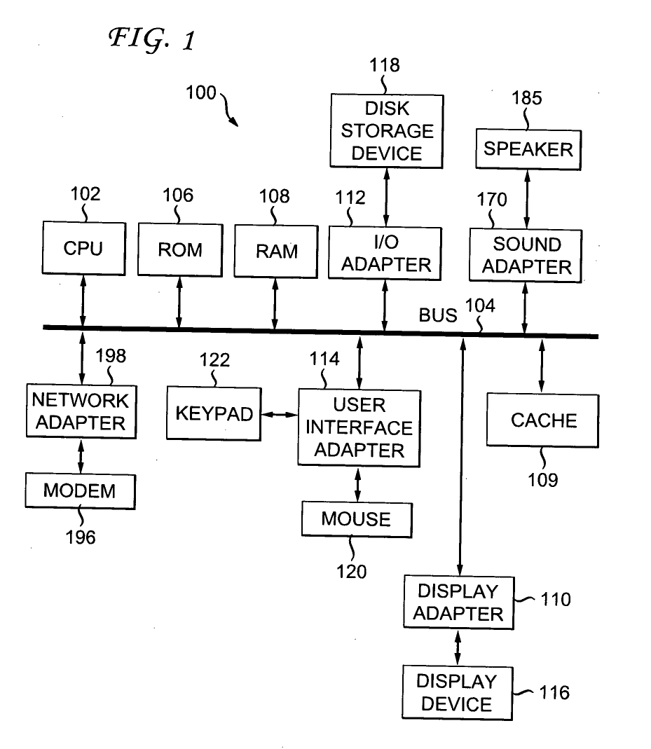

Turning to FIG. 1, an exemplary computer system to which the present invention may be applied is indicated generally by the reference numeral 100. The computer processing system 100 includes at least one processor (CPU) 102 coupled in signal communication with other components via a system bus 104. A read only memory (ROM) 106, a random access memory (RAM) 108, a display adapter 110, an input/output (I/O) adapter 112, a user interface adapter 114, a sound adapter 170, and a network adapter 198, are connected in signal communication with the system bus 104.

A display device 116 is connected in signal communication with the system bus 104 through the display adapter 110. A disk storage device (e.g., a magnetic or optical disk storage device) 118 is connected in signal communication with the system bus 104 through the I/O adapter 112.

A mouse 120 and keyboard 122 are connected in signal communication with the system bus 104 through the user interface adapter 114. The mouse 120 and keyboard 122 are used to input and output information to and from the system 100.

At least one speaker (herein after “speaker”) 185 is connected in signal communication with the system bus 104 though the sound adapter 170.

A (digital and/or analog) modem 196 is connected in signal communication with the system bus 104 through the network adapter 198. It is to be appreciated that some embodiments, one or more elements of system 100 may be omitted and/or other elements may be included. For example, in one or more other embodiments of system 100, the speaker 185 and sound adapter 170 may be omitted. In yet one or more other embodiments of system 100, the network adapter 198 may be omitted. Given the teachings of the present principles provided herein, one of ordinary skill in this and related arts will contemplate these and various other configurations of system 100, while maintaining the spirit and scope of the present principles.

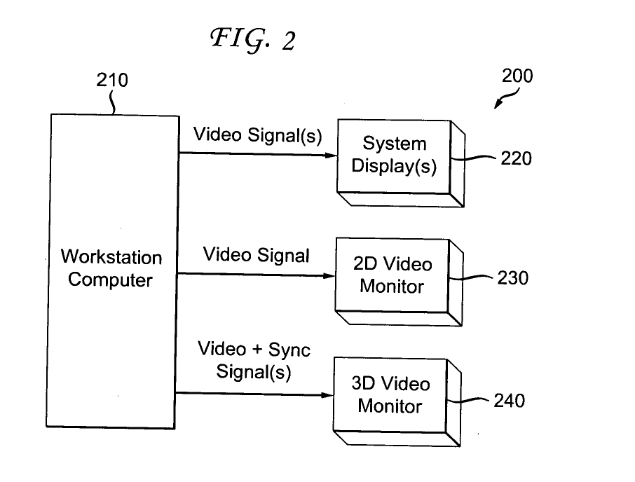

Thus, FIG. 1 shows a computer capable of implementing one or more embodiments of the present principles. While FIG. 1 essentially represents a general purpose computer suitable for practicing one or more embodiments of the present principles, a more specialized embodiment of a computer is shown with respect to FIG. 2.

Turning to FIG. 2, an exemplary integrated 2D/3D workstation is indicated generally by the reference numeral 200. The workstation 200 includes a workstation computer 210 having a first output connected in signal communication with an input of a system display 220, for providing a video signal(s). A second output of the workstation 200 is connected in signal communication with an input of a 2D video monitor 230, for providing a video signal. A third output of the workstation 200 is connected in signal communication with an input of a 3D video monitor 240, for providing video and synchronization (sync) signals.

It is to be appreciated that the workstation computer 210 may include one or more elements of FIG. 1 including, but not limited to, one or more processors, one or more memories, and adapters such as video adapters, I/O adapters, user interface adapters, network adapters. Regarding the aforementioned adapters, of course one or more of such adapters may be included in the workstation computer 210.

In an embodiment, the workstation computer 210 includes a single integrated user interface for receiving input video production commands relating to both two-dimensional video data and three-dimensional video data.

In an embodiment, the following design is used. The workstation computer is a DELL PRECISION T5500 with 4 video outputs. Each video output is capable of driving a monitor via a video graphics adapter (VGA), a digital video interface (DVI), a high definition multimedia interface (HDMI), or a DisplayPort cable. A single graphics card is used for driving two monitors for displaying the PC desktop, through which the user interacts with the operating system and application software. This desktop could alternatively be displayed on a single monitor (as shown in FIG. 2), or on more than 2 monitors.

In an embodiment, we use two or more video cards for driving the 2D and 3D video output. In particular, one video card delivers the 2D video and another video card delivers the 3D video. It is also possible to drive both the 2D and 3D video outputs with a single graphics card.

Given the teachings of the present principles provided herein, one of ordinary skill in this and related arts will contemplate these and other variations and implementations of a system capable of implementing the present principles, while maintaining the spirit of the present principles.

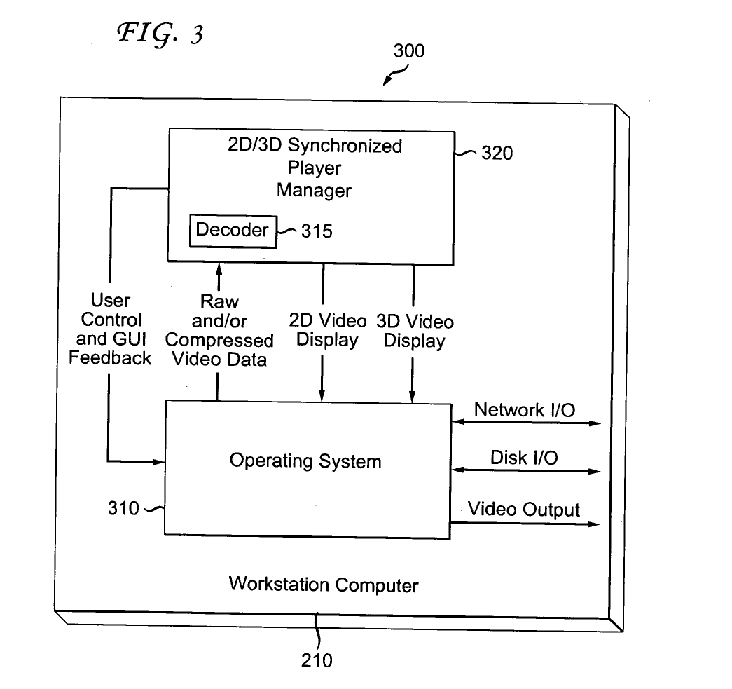

Turning to FIG. 3, an exemplary software arrangement for the integrated 2D/3D workstation 200 shown in FIG. 2 is indicated generally by the reference numeral 300. The software arrangement 300 includes an operating system 310 connected in signal communication with a 2D/3D synchronized player manager 320. Raw and/or compressed video data is provided from the operating system 310 to the 2D/3D synchronized player manager 320. 2D video display data and 3D video display data are provided from the 2D/3D synchronized player manager 320 to the operating system 310. User control and graphical user interface (GUI) feedback data are exchanged between the 2D/3D synchronized player manager 320 and the operating system 310. Network I/O data and disk I/O data are exchanged between the operating system 310 and other elements (not shown in FIG. 3) of the workstation. Video data is output from the operating system to one or more displays (not shown in FIG. 3).

In an embodiment, the 2D/3D synchronized player manager 320 includes one or more video decoders 315. It is to be appreciated that in other embodiments, one or more video decoders may be arranged as separate elements with respect to the 2D/3D synchronized player manager 320. Moreover, it is to be appreciated that in yet other embodiments, one or more video decoders may include the 2D/3D synchronized player manager. It is to be further appreciated that the 2D/3D synchronized player manager 320 may also include and/or otherwise cooperate with an integrated user interface for receiving video production commands which are then managed (implemented) by the 2D/3D synchronized player manager. Of course, regarding the overall invention, such integrated user interface will involve multiple elements including the 2D/3D synchronized player manager 320 and one or more displays that display visual data pertinent to the user interface, the latter (one or more displays) thus forming a graphical user interface (GUI) portion of the single integrated user interface.

Moreover, while shown in FIG. 3 as primarily software, a decoder in accordance with an embodiment of the present principles may be implemented in software, hardware, or a combination of the software and hardware, while maintaining the spirit of the present principles. It is to be appreciated that in even in primarily software applications, a decoder in accordance with the present principles will at the least include and/or otherwise interface with an utilize at least one processor and at least one memory device.

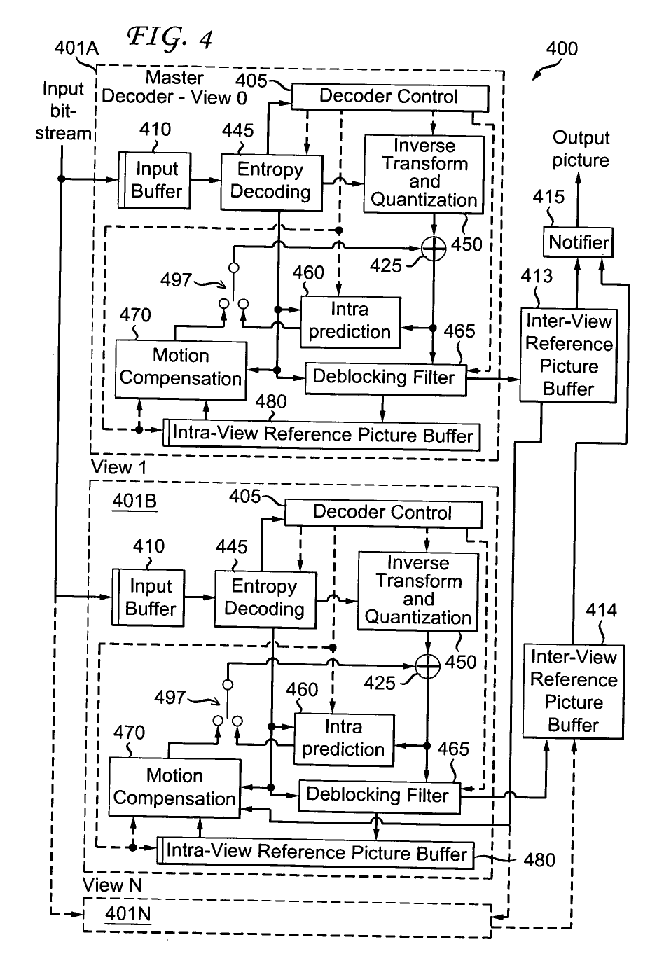

Turning to FIG. 4, an exemplary multi-view video decoder is indicated generally by the reference numeral 400. The video decoder 400 includes respective view decoders 401A through 401N, corresponding to views 0 through N. In the embodiment of FIG. 4, the view decoder 401A, corresponding to view 0, is considered the master decoder. Each of the respective view decoders 401A through 401N includes an input buffer 410 having an output connected in signal communication with a first input of an entropy decoder 445. A first output of the entropy decoder 445 is connected in signal communication with a first input of an inverse transformer and inverse quantizer 450. An output of the inverse transformer and inverse quantizer 450 is connected in signal communication with a second non-inverting input of a combiner 425. An output of the combiner 425 is connected in signal communication with a second input of a deblocking filter 465 and a first input of an intra prediction module 460. A second output of the deblocking filter 465 is connected in signal communication with a first input of an intra-view reference picture buffer 480. An output of the intra-view reference picture buffer 480 is connected in signal communication with a second input of a motion compensator 470.

A second output of the entropy decoder 445 is connected in signal communication with a third input of the motion compensator 470, a first input of the deblocking filter 465, and a third input of the intra predictor 460. A third output of the entropy decoder 445 is connected in signal communication with an input of a decoder controller 405. A first output of the decoder controller 405 is connected in signal communication with a second input of the entropy decoder 445. A second output of the decoder controller 405 is connected in signal communication with a second input of the inverse transformer and inverse quantizer 450. A third output of the decoder controller 405 is connected in signal communication with a third input of the deblocking filter 465. A fourth output of the decoder controller 405 is connected in signal communication with a second input of the intra prediction module 460, a first input of the motion compensator 470, and a second input of the intra-view reference picture buffer 480.

An output of the motion compensator 470 is connected in signal communication with a first input of a switch 497. An output of the intra prediction module 460 is connected in signal communication with a second input of the switch 497. An output of the switch 497 is connected in signal communication with a first non-inverting input of the combiner 425.

An input of the input buffer 410 of each of the views decoders 401A through 401N is available as an input the decoder 400, for receiving an input bitstream. A first output of the deblocking filter 465 of view decoder 401A is connected in signal communication with an input of an inter-view reference picture buffer 413. A first output of the deblocking filter 465 of view decoder 401B is connected in signal communication with a first input of an inter-view reference picture buffer 414. A first output of the inter-view reference picture buffer 413 is connected in signal communication with a fourth input of motion compensator 470 of view decoder 401B (and is similarly connected with respect to a similar element in view N in the case when view N is present and view decoder N is used). A second output of the inter-view reference picture buffer 413 is connected in signal communication with a first input of a notifier 415. An output of the inter-view reference picture buffer 414 is connected to a second input of the notifier 415. An output of the notifier 415 is available as an output of the decoder 400, for outputting an output picture.

As noted above, the present principles are directed to a method and apparatus for a synchronized workstation with 2D and 3D outputs. It has been recognized that video production work is a very tedious and time-consuming process, and any business having the use of tools which reduce the amount of labor required to ensure a high-quality video product will have an advantage over their competitors. Advantageously, the present principles provide a single integrated interface through which a worker (operator) may perform video production tasks as well as perform an immediate quality analysis of the processed video in either 2D or 3D viewing modes at any time or both simultaneously.

Some of the video production tasks to which the present principles may be applied include, but are not limited to, pre-processing, filtering, and/or post-processing. Given the teachings of the present principles provided herein, one of ordinary skill in this and related arts will contemplate these and other video production tasks to which the present principles may be applied, while maintaining the spirit of the present principles.

It is to be appreciated that our system supports a feature called “vertical retrace synchronization” on both the 2D and 3D video outputs. This is a highly desirable feature for video playback. Video frames are delivered sequentially, pixel by pixel, from the video card in a computer to the display monitor. If this feature is not present, then the video card may switch between one video frame and the next frame while it is in the middle of delivering a frame to the monitor. If this happens, then a portion of the displayed image on the monitor will be taken from one particular video frame, and another (e.g., lower) portion of the image will be from the following video frame. This results in an objectionable video artifact called “tearing”. In order to prevent this artifact, the entire system (application software, operating system, video card drivers and hardware) should support vertical retrace synchronization, so that the pixel output of the video card to the monitor will only switch from one video frame to the next during the time between successive images.

In one embodiment, the software design of our system includes the LINUX operating system, X-WINDOWS display software, Qt cross-platform application framework, NVIDIA graphics card drivers, and TIGER3D player application software. However, it is of course to be appreciated that the present principles could also be implemented with other operating systems, other application frameworks, other video card drivers, and other application software.

The 2D/3D synchronized player manager 320 receives commands from the user via its Graphical User Interface (GUI) on the desktop display of the workstation. Examples of commands which may be received include, but are not limited to: Play Continuous; Play a Scene; Stop; Forward or Backward 1 Frame; Forward or Backward 5 seconds; and so forth. The 2D/3D synchronized player manager 320 can read uncompressed video data from local disk storage or network storage. The 2D/3D synchronized player manager 320 can also read compressed video data (from local or network storage) and uncompress the video data using an integrated decoder.

While working in 3D mode, the 2D/3D synchronized player manager 320 reads (and decodes if necessary) two different images for each video frame, called the “left” view and the “right” view. For each video frame, the 2D/3D synchronized player manager 320 sends only one view (either the right view or the left view, as chosen by the user) to the 2D display, while the 2D/3D synchronized player manager 320 sends both views (left and right) to the 3D display.

By integrating three separate displays (desktop display, 2D video output, and 3D video output) into a single workstation, the present principles allow a video production business to be more efficient by allowing multiple workers to verify the quality of both 2D and 3D video simultaneously, or allowing a single worker to switch back and forth between 2D video and 3D video as necessary with practically no effort.

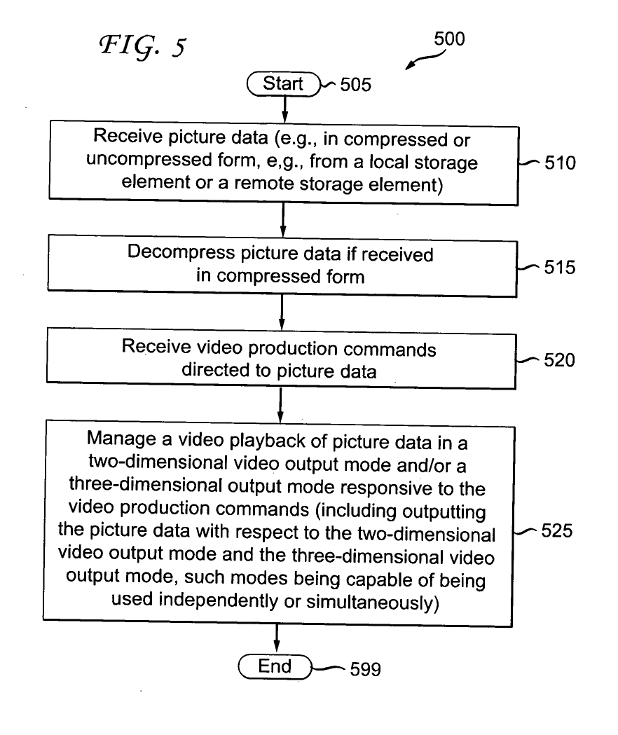

Turning to FIG. 5, an exemplary method for synchronizing two-dimensional and three-dimensional video outputs is indicated generally by the reference numeral 500. The method 500 may be practiced, for example, on a computer system such as computer system 100 of FIG. 1, or a workstation such as workstation 200 of FIG. 2, or a decoder such as decoder 400 of FIG. 4, or with respect to an application such as 2D/3D synchronized player manager 320 of FIG. 3. Of course, given the teachings of the present principles provided herein, one of ordinary skill in this and related arts will contemplate these and other apparatus and systems to which the present principles may be applied, while maintaining the spirit of the present principles. The method 500 includes a start block 505 that passes control to a function block 510. The function block 510 receives picture data (e.g., in a compressed or uncompressed form, e.g., from a local storage element and/or a remote storage element), and passes control to a function block 515. The function block 515 decompresses the picture data if the picture data is received in a compressed form, and passes control to a function block 520. The function block 520 manages a video playback of picture data in a two-dimensional video output mode and/or a three-dimensional output mode responsive to the video production commands (including outputting the picture data with respect to the two-dimensional video output mode and/or the three-dimensional video output mode, such modes being capable of being used independently or simultaneously), and passes control to an end block 599.

A description will now be given of some of the many attendant advantages/features of the present invention, some of which have been mentioned above. For example, one advantage/feature is an apparatus having a video decoder for decoding picture data. The video decoder includes a data manager for receiving video production commands and managing a video playback of the picture data in at least one of a two-dimensional video output mode and a three-dimensional video output mode responsive to the video production commands. The two-dimensional video output mode and the three-dimensional video output mode are capable of being used independently and simultaneously.

Another advantage/feature is the apparatus having the video decoder as described above, wherein the video production commands include at least one of pre-processing, filtering, and post-processing.

Yet another advantage/feature is the apparatus having the video decoder as described above, wherein the video production commands relate to a quality analysis of the picture data in at least one of the two-dimensional video output mode and the three-dimensional video output mode.

Still another advantage/feature is the apparatus having the video decoder as described above, wherein video frames corresponding to at least one of the two-dimensional video output mode and the three-dimensional video output mode are output sequentially, pixel by pixel, for display on one or more display devices, such that switching from a current video frame to a next video frame only occurs after the current image has been entirely displayed.

Moreover, another advantage/feature is the apparatus having the video decoder as described above, wherein the picture data is received as uncompressed video data from at least one of a local storage element and a remote storage element.

Further, another advantage/feature is the apparatus having the video decoder wherein the picture data is received as uncompressed video data from at least one of a local storage element and a remote storage element as described above, wherein at least one of the local storage element and the remote storage element is a network storage element.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. An apparatus, comprising:
a video decoder for decoding picture data, said video decoder comprising a data manager for receiving video production commands and managing a video playback of the picture data in at least one of a two-dimensional video output mode and a three-dimensional video output mode responsive to the video production commands, wherein the two-dimensional video output mode and the three-dimensional video output mode are capable of being used independently and simultaneously.

2. The apparatus of claim 1, wherein the video production commands comprise at least one of pre-processing, filtering, and post-processing.

3. The apparatus of claim 1, wherein the video production commands relate to a quality analysis of the picture data in at least one of the two-dimensional video output mode and the three-dimensional video output mode.

4. The apparatus of claim 1, wherein video frames corresponding to at least one of the two-dimensional video output mode and the three-dimensional video output mode are output sequentially, pixel by pixel, for display on one or more display devices, such that switching from a current video frame to a next video frame only occurs after the current image has been entirely displayed.

5. The apparatus of claim 1, wherein the picture data is received as uncompressed video data from at least one of a local storage element and a remote storage element.

6. The apparatus of claim 5, wherein at least one of the local storage element and the remote storage element is a network storage element.

7. In a video decoder, a method, comprising:
receiving video production commands; and
managing a video playback of picture data in at least one of a two-dimensional video output mode and a three-dimensional video output mode responsive to the video production commands, wherein the two-dimensional video output mode and the three-dimensional video output mode are capable of being used independently and simultaneously.

8. The method of claim 7, wherein the video production commands comprise at least one of pre-processing, filtering, and post-processing.

9. The method of claim 7, wherein the video production commands relate to a quality analysis of the picture data in at least one of the two-dimensional video output mode and the three-dimensional video output mode.

10. The method of claim 7, wherein video frames corresponding to at least one of the two-dimensional video output mode and the three-dimensional video output mode are output sequentially, pixel by pixel, for display on one or more display devices, such that switching from a current video frame to a next video frame only occurs after the current image has been entirely displayed.

11. The method of claim 7, wherein the picture data is received as uncompressed video data from at least one of a local storage element and a remote storage element.

12. The method of claim 11, wherein at least one of the local storage element and the remote storage element is a network storage element.
